(19) United States
(12) Patent Application Publication
(10) Pub. No.: US 2021/0402313 A1
(43) Pub. Date: Dec. 30, 2021

(54) ROBOT

(71) Applicant: LG ELECTRONICS INC., Seoul (KR)

(72) Inventors: Seyoung WOO, Seoul (KR); Jeongho PARK, Seoul (KR); Ikhee JO, Seoul (KR)

(21) Appl. No.: 16/765,304

(22) PCT Filed: Jun. 14, 2019
(86) PCT No.: PCT/KR2019/007223

§ 371 Date: May 19, 2020

(51) Int. Cl. A63H 13/00; B25J 9/00; B25J 9/10

(52) U.S. Cl. CPC A63H 13/005; A63H 2200/00; B25J 9/106; B25J 9/0009

(57) ABSTRACT

A robot according to an embodiment of the present invention includes: a head part; an ear rotatably connected to the head part; a moving frame connected to the head part, the moving frame moving vertically to allow the ear to rotate; a neck body coupled to the heat part; a main actuator configured to allow the neck body to rotate; and sub actuator configured to allow the moving frame to move vertically. The main actuator and the sub actuator may be disposed to be symmetrical to each other with respect to the neck body.

### TECHNICAL FIELD

The present invention relates to a robot, and more particularly, to a robot including at least one actuator for driving a head.

### BACKGROUND ART

Robots have been developed for industrial use in order to be part of factory automation. In recent years, fields of application of the robots have been expanded, and thus, robots that are used in everyday life as well as medical robots and aerospace robots are being developed.

Particularly, pet robots modeled from a shape of a pet like a dog may provide emotional satisfaction to the user. Such a pet robot may operate similar to a real pet and output a sound. Since the pet robot does not need to feed or clean up waste thereof, the pet robot may reduce the hassle and burden of busy modern people while providing emotional satisfaction just like a real pet.

### DISCLOSURE OF THE INVENTION

### Technical Problem

An object of the present invention is to provide a robot that allows an ear to rotate with respect to a head part.

Another object of the present invention is to provide a robot having an improved movable balance of a head part.

### Technical Solution

A robot according to an embodiment of the present invention has a feature in which a main actuator that allows a head part to rotate and a sub actuator that drives an ear are disposed to be symmetrical to each other with respect to a neck body. Thus, since biasing of a load applied to drive the head part is minimized, a movable balance, i.e., a dynamic characteristic of the head part may be improved.

In more detail, a robot according to an embodiment of the present invention includes: a head part; an ear rotatably connected to the head part; a moving frame connected to the head part, the moving frame moving vertically to allow the ear to rotate; a neck body coupled to the heat part; a main actuator configured to allow the neck body to rotate; and a sub actuator configured to allow the moving frame to move vertically. The main actuator and the sub actuator may be disposed to be symmetrical to each other with respect to the neck body.

A rotation axis of the main actuator and a rotation axis of the sub actuator may be disposed in a straight line.

An opening configured to avoid an interference with the neck body may be defined in the moving frame.

The main actuator and the sub actuator may contact both sides of the neck body, respectively.

The robot may further include: a crank body connected to the sub actuator; and a connecting rod configured to connect the crank body to the moving frame. The moving frame may include a rod connector connected to the connecting rod.

The connecting rod may include: an insertion groove into which a joint disposed on the crank body is rotatably inserted; a first slit into which a joint disposed on the rod connector is movably inserted; and a second slit into which a joint disposed on the neck body is movably inserted.

The neck body may include: an accommodation groove in which the crank body and the connecting rod are disposed; and a through-groove which communicates with the accommodation groove and through which the rod connector passes.

The head part may include: a head; and a guide body coupled to a rear surface of the head, the guide body being configured to guide the vertical movement of the moving frame.

At least one of the moving frame or the guide body may have a bilaterally symmetrical shape.

At least one guide rib protruding from a rear surface of the guide body to guide the moving frame may be disposed on the guide body.

The guide rib may include: a protrusion protruding backward from the guide body; and a restriction portion bent from a rear end of the protrusion to restrict forward and backward movement of the moving frame.

The ear may include: an ear body disposed above or outside the head; and an ear connection portion connected to the ear body, disposed between the head and the guide body, and connected to the moving frame.

The ear connection portion may include: an insertion hole into which a joint disposed on the guide body is rotatably inserted; and a slit into which a joint disposed on the moving frame is rotatably inserted.

The moving frame may include: a pair of main frames lengthily disposed in a vertical direction, the pair of main frames being disposed at a rear side of the guide body; a movable frame connected to the ear to allow the ear to rotate, the movable frame being disposed between the head and the guide body; and a connection frame configured to connect the main frames to the movable frame.

The moving frame may include: a pair of main frames spaced apart from each other with the neck body therebetween, the pair of main frames being lengthily disposed in a vertical direction; a movable frame connected to the ear to allow the ear to rotate; and a connection frame configured to connect to the main frames to the movable frame.

The pair of main frames may contact both ends of the neck body, respectively.

The moving frame may further include: a lower frame disposed below the neck body to connect the pair of main frames to each other; and a rod connector protruding upward from the lower frame, the rod connector being connected to a connecting rod configured to transmit power of the sub actuator.

The robot may further include: a movable body to which the main actuator and the sub actuator are fixed and to which the neck body is rotatably connected; and a moving actuator configured to allow the movable body to rotate.

The movable body may have a bilaterally symmetrical shape.

A robot according to an embodiment of the present invention includes: a body part; a head part spaced upward from the body part; a neck body coupled to the head part; a movable assembly configured to connect the body part to the neck body, the movable assembly including a plurality of movable bodies that are connected to be rotatable with respect to each other; a moving frame connected to the head part so as to be movable vertically; a main actuator configured to allow the neck body to rotate; and a sub actuator configured to allow the moving frame to move vertically. The main actuator and the sub actuator may be fixed to the movable assembly and be symmetrical to each other with respect to the neck body.

### Advantageous Effects

According to the preferred embodiment of the present invention, since the main actuator and the sub actuator are disposed symmetrically with respect to the neck body, the biasing of the load applied to drive the head part may be minimized to improve the movable balance, i.e., the dynamic characteristic of the head part.

Also, the rotation axis of the main actuator and the rotation axis of the sub actuator may be disposed in the straight line. Thus, the movable balance of the head part may be further improved.

Also, the opening may be defined in the moving frame to avoid the interference of the neck body. Thus, the moving frame may smoothly move vertically without interfering with the neck body.

Also, since the main actuator and the sub actuator are disposed symmetrically in contact with both the sides of the neck body.

Also, since the rotational force of the sub actuator is transmitted to the moving frame through the crank body and the connecting rod, the rotational force may be smoothly converted into the vertical moving force of the moving frame.

Also, since the insertion groove, the first slit, and the second slit are defined in the connecting rode, the connecting rod may smoothly operate while being connected to the crank body, the moving frame, and the neck body, respectively.

Also, the crank body and the connecting rod may be accommodated in the accommodation groove of the neck body. Thus, the crank body and connecting rod may be protected, and also, the robot may be compact.

Also, the through-groove which communicates with the accommodation groove and through which the rod connector of the moving frame passes may be defined in the neck body. Thus, the rod connector may be smoothly connected to the connecting rod disposed in the accommodation groove.

Also, the guide body may be coupled to the rear surface of the head to guide the vertical movement of the moving frame. Thus, the moving frame may reliably move vertically.

Also, at least one of the moving frame or the guide body may have a bilaterally symmetrical shape. Thus, the operation balance of the head part may be further improved.

Also, the guide rib may be disposed on the guide body to reliably guide the moving frame.

Also, the guide rib may include a restriction portion that restricts the moving frame in the front and rear direction. Thus, the moving frame may be prevented from being separated backward.

Also, an ear connection portion connected to the moving frame may be disposed between the head and the guide body. Thus, the ear connection portion may be protected, and the outer appearance of the robot may not be seen from the outside to improve the outer appearance of the robot in design.

Also, the insertion hole and the slit may be defined in the ear connection portion. Thus, the ear may rotate about the joint inserted into the insertion hole, and when the joint connected to the slit moves vertically, the ear may rotate.

Also, the moving frame may include the connection frame connecting the main frame disposed at the rear side of the guide body to the movable frame disposed between the head and the guide body. Thus, the moving frame may easily connect the ear and the crank, which are disposed at the opposite sides with respect to the guide body, to each other.

Also, the pair of main frames may contact both the ends of the neck body, respectively. Thus, the neck body may easily guide the vertical movement of the moving frame.

Also, the rod connector connected to the connecting rod may protrude upward from the lower frame connecting the pair of main frames to each other. Thus, the rod connector may be smoothly connected to the connecting rod at the lower side of the neck body.

Also, the movable body to which the main actuator and the sub actuator are fixed may rotate by the moving actuator. Thus, the main actuator and the sub actuator may be disposed adjacent to the head part while increasing in degree of freedom of the movement of the head part.

Also, the movable body may have the bilaterally symmetrical shape. Thus, the movable balance of the head part may be further improved.

### BRIEF DESCRIPTION OF THE DRAWINGS

FIG. 1 is a side view of a robot according to an embodiment of the present invention.

FIG. 2 is a rear perspective view of the robot according to an embodiment of the present invention.

FIG. 3 is a rear view of a head part and a movable assembly according to an embodiment of the present invention.

FIG. 4 is a side view of the head part and the movable assembly according to an embodiment of the present invention.

FIG. 5 is a view of the head part when viewed from a rear side according to an embodiment of the present invention.

FIG. 6 is a view of the head part when viewed from a front side according to an embodiment of the present invention.

FIG. 7 is a cross-sectional view for explaining a connection relationship between a guide body and a moving frame according to an embodiment of the present invention.

FIGS. 8A and 8B are views illustrating vertical movement of the moving frame according to an embodiment of the present invention.

FIG. 9 is a perspective view of a crank body according to an embodiment of the present invention.

FIG. 10 is a view of a connecting rod when viewed from one side according to an embodiment of the present invention.

FIG. 11 is a view of the connecting rod when viewed from the other side according to an embodiment of the present invention.

### MODE FOR CARRYING OUT THE INVENTION

Hereinafter, detailed embodiments of the present invention will be described in detail with reference to the accompanying drawings.

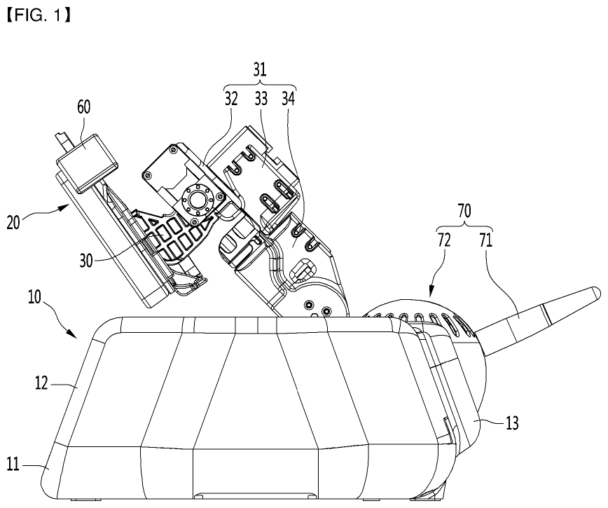

FIG. 1 is a side view of a robot according to an embodiment of the present invention.

A robot according to an embodiment of the present invention may include a body part 10, a head part 20, a neck body 30, and a movable assembly 31.

An inner space may be defined in the body part 10. For example, a controller (not shown) controlling an overall operation of the robot and a battery (not shown) supplying power to the robot may be provided in the inner space.

In more detail, the body part 10 may include a base 11 and a body cover 12 disposed above the base 11 to cover the base 11.

The base 11 may define a bottom surface of the body part 10. A movable wheel (not shown) for traveling of the robot may be provided on the base 11.

The body cover 12 may be coupled to the base 11 at an upper side of the base 11. The inner space of the body part 10 may be defined between the base 11 and the body cover 12.

The head part 20 may correspond to a head of the robot. The head part 20 may be provided with a display displaying various pieces of information, photographs, or videos, which are represented by letters or pictures. The display may be provided on a front surface of the head part 20.

The head part 20 may be disposed above the body part 10. However, the present invention is not limited thereto, and the head part 20 may be disposed at an upper front side of the body part 10. Also, the head part 20 may be spaced apart from the body part 10.

An ear 60 may be provided on the head part 20. The ear 60 may be provided in a left and right pair. The ear 60 may be rotatably connected to the head part 20. Thus, the ear 60 may alternately move with respect to the head part 20 so as to be similar to an actual pet.

The neck body 30 may be coupled to the head part 20. In more detail, the neck body 30 may be coupled to a rear surface of the head part 20. The neck body 30 may move together with the head part 20.

The movable assembly 31 may allow the heat part 20 to move with respect to the body part 10. It is preferable that the movable assembly 31 allows the head part 20 to move to three or more degrees of freedom.

The movable assembly 31 may connect the neck body 30 to the body part 10. The movable assembly 31 may be disposed above the body part 10.

The movable assembly 31 may include a plurality of movable bodies 32, 33, and 34. One movable body may be rotatably connected to the other movable body that is adjacent to the one movable body. A rotation axis of the one movable body is preferably perpendicular to a rotation axis of the other movable body.

For example, the movable assembly 31 may include first to third movable bodies 32, 33, and 34.

The neck body 30 may be rotatably connected to the first movable body 32. The first movable body 32 may be rotatably connected to the second movable body 33. The second movable body 33 may be rotatably connected to the third movable body 34. The third movable body 34 may be rotatably connected to the body part 10.

In this case, the head part 20 may operate in four degrees of freedom with respect to the body part 10 and may realize various operations similar to a head of the actual pet.

On the other hand, the robot according to an embodiment of the present invention may further include a tail part 70.

The tail part 70 may be connected to a rear portion of the body part 10.

The tail part 70 may include a tail 71 and a tail driver 72.

The tail 71 may correspond to a tail of the pet. The tail 71 may be connected to the tail driver 72.

The tail driver 72 may drive the tail 71. The tail driver 72 may have an approximately spherical shape and may allow the tail 71 to move to two degrees of freedom. The body part 10 may include an actuator (not shown) that provides rotational power to the tail driver 72.

The tail driver 72 may be mounted to the rear portion of the body part 10. That is, a rear mounting part 13 on which the tail driver 72 is mounted may be disposed on the rear portion of the body part 10.

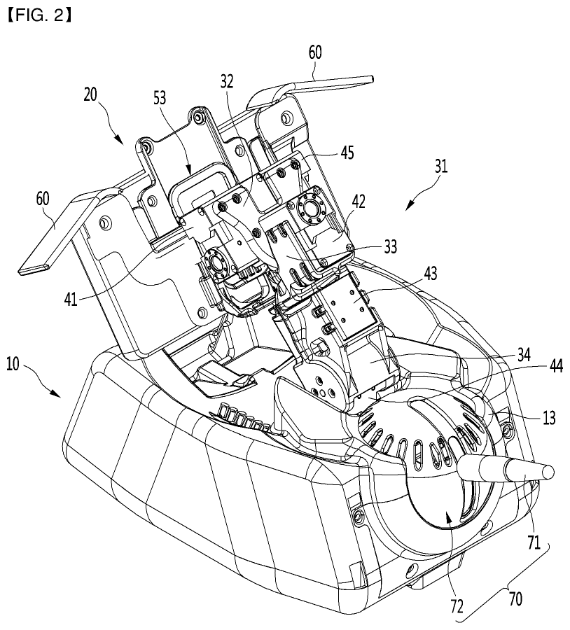

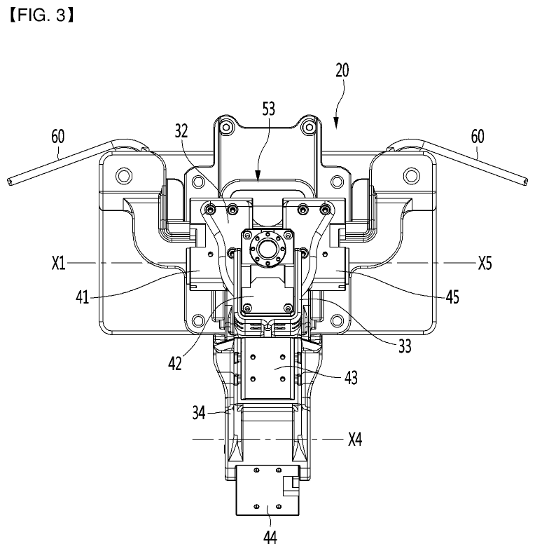

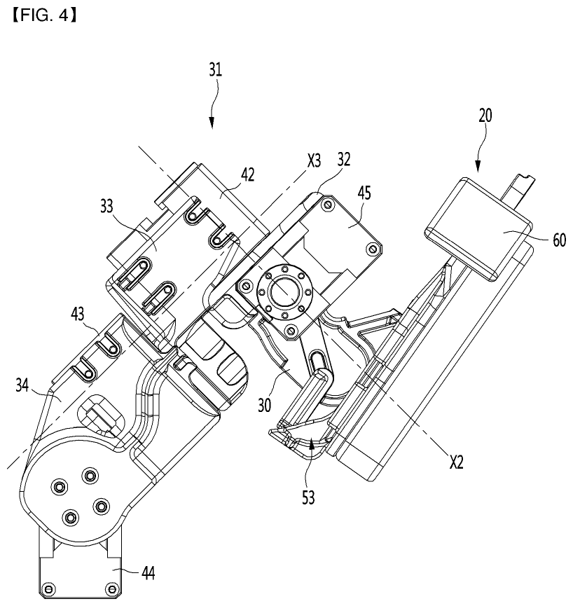

FIG. 2 is a rear perspective view of the robot according to an embodiment of the present invention, FIG. 3 is a rear view of the head part and the movable assembly according to an embodiment of the present invention, and FIG. 4 is a side view of the head part and the movable assembly according to an embodiment of the present invention.

The robot according to this embodiment includes a main actuator 41 that allows the neck body 30 to rotate, and moving actuators 42, 43, and 44 that allow the movable bodies 32, 33, and 34 to rotate, and a sub actuator 45 that provides rotational power of the ear 60.

Each of the main actuator 41, the moving actuators 42, 43, and 44 and the sub actuator 45 may be a motor. Each of the main actuator 41 and the moving actuators 42, 43, and 44 may be a bidirectional rotary motor. On the other hand, the sub actuator 45 may be a one-way rotary motor or a two-way rotary motor.

The main actuator 41 may be fixed to the first movable body 32.

The main actuator 41 may be connected to the neck body 30 and may allow the neck body 30 to rotate with respect to the first movable body 32.

A rotation axis X1 of the main actuator 41 may be lengthily defined horizontally. Thus, the main actuator 41 may tilt the neck body 30 vertically. Since the neck body 30 is coupled to the head part 20, the head part 20 may be tilted together with the neck body 30.

The number of moving actuators 42, 43, and 44 may correspond to the number of movable bodies 32, 33, and 34 provided in the movable assembly 31. For example, the plurality of moving actuators may include first to third moving actuators 42, 43, and 44.

The first moving actuator 42 may be fixed to the second movable body 33.

The first moving actuator 42 may be connected to the first movable body 32 and may allow the first movable body 32 to rotate with respect to the second movable body 33. Since the main actuator 41 is fixed to the first movable body 32, the main actuator 41 may rotate together with the first movable body 32.

A rotation axis X2 of the first moving actuator 42 may be perpendicular to the rotation axis X1 of the main actuator 41.

The second moving actuator 43 may be fixed to the third movable body 34.

The second moving actuator 43 may be connected to the second movable body 33 and may allow the second movable body 33 to rotate with respect to the third movable body 34. Since the first moving actuator 42 is fixed to the second movable body 33, the first moving actuator 42 may rotate together with the third movable body 32.

A rotation axis X3 of the second moving actuator 43 may be perpendicular to the rotation axis X1 of the main actuator 41 and the rotation axis X2 of the first moving actuator 42.

The third moving actuator 44 may be fixed to the body part 10.

The third moving actuator 44 may be connected to the third movable body 34 and may allow the third movable body 34 to rotate with respect to the body part 10.

A rotation axis X4 of the third moving actuator 44 may be parallel to the rotation axis X1 of the main actuator 41, and the rotation axis X2 of the first moving actuator 42 may be perpendicular to the rotation axis X3 of the second moving actuator 43. That is, the rotation axis X4 of the third moving actuator 44 may be lengthily defined horizontally

Thus, the third moving actuator 44 may tilt the third movable body 34 vertically. Since the second moving actuator 43 is fixed to the third movable body 34, the second moving actuator 43 may be tilted together with the third movable body 34.

An output of each of the actuators may preferably increase in order of the main actuator 41, the first moving actuator 42, the second moving actuator 43, and the third moving actuator 44. This is done because a moving load increases from the head part 20 to the body part 10.

For example, a load by which the head part and the neck body 30 are driven may be applied to the main actuator 41, which is closest to the head part 20, among the plurality of actuators 41, 42, 43, and 44. On the other hand, a load by which the head part 20, the neck body 30, the main actuator 41, the first movable body 32, the first moving actuator 42, the second movable body 33, the second moving actuator 43, and the third movable body 34 are driven may be applied to the third moving actuator 44, which is closest to the body part 10, among the plurality of actuators 41, 42, 43, and 44.

The sub actuator 45 may allow the moving frame 53 to be described later to move vertically so as to provide power by which the ear 60 alternately moves with respect to the head part 20.

The sub actuator 45 may be fixed to the first movable body 32, like the main actuator 41.

The sub actuator 45 may be disposed at a side opposite to the main actuator 41 with respect to the neck body 30. Both sides of the neck body 30 may contact the main actuator 41 and the sub actuator 45, respectively. The neck body 30 may be restricted in the horizontal direction between the main actuator 41 and the sub actuator 45.

The main actuator 41 and the sub actuator 45 may be disposed symmetrically with respect to the neck body 30. Thus, a movable balance, i.e., a dynamic characteristic of the movable assembly 31 may be improved.

A rotation axis X5 of the sub actuator 45 and the rotation axis X1 of the main actuator 41 may be parallel to each other and may be preferably disposed in a straight line.

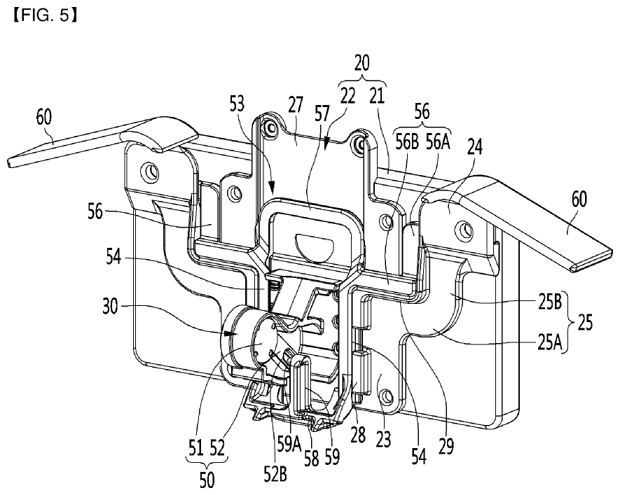

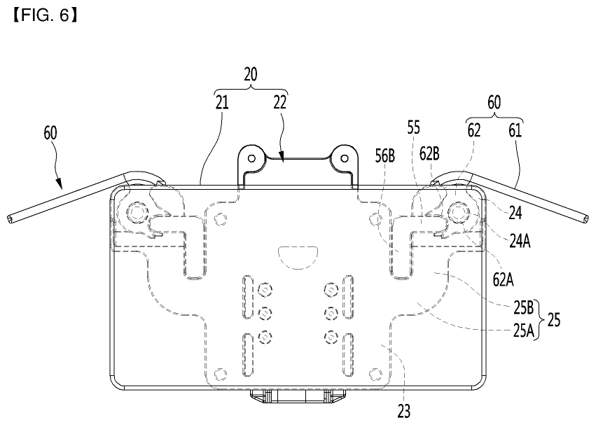

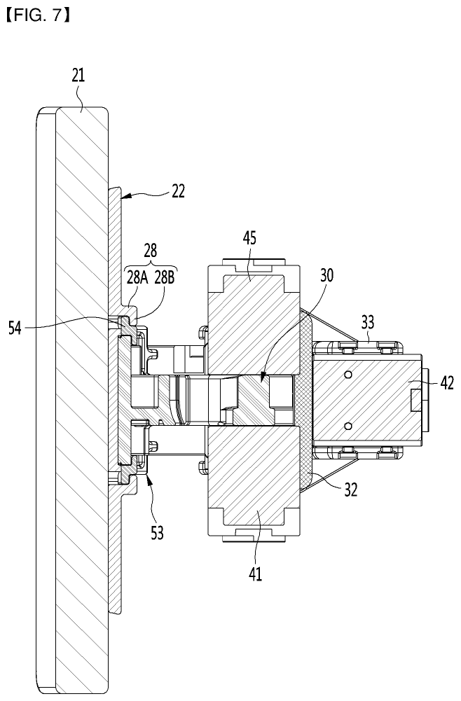

FIG. 5 is a view of the head part when viewed from a rear side according to an embodiment of the present invention, FIG. 6 is a view of the head part when viewed from a front side according to an embodiment of the present invention, and FIG. 7 is a cross-sectional view for explaining a connection relationship between a guide body and the moving frame according to an embodiment of the present invention.

The head part 20 may include a head 21 and a guide body 22.

The head 21 may have an approximately rectangular parallelepiped shape, but is not limited thereto. A display may be disposed on a front surface of the head 21.

The guide body 22 may be coupled to a rear surface of the head 21. The guide body 22 may guide vertical movement of the moving frame 53 to be described later.

The guide body 22 may have a symmetrical shape in the horizontal direction. The guide body 22 may be integrally provided.

The guide body 22 has a center portion 23 to which the neck body 30 is coupled, a side portion 24 to which the ear 60 is connected, and a connection portion 25 connecting the center portion 23 to the side portion 24.

The center portion 23 may have an approximately panel shape. The center portion 23 may be coupled to the rear surface of the head 21. The center portion 23 may be a center portion of the guide body 22.

The side portion 24 may be disposed at a side of the center portion 23. The side portion 24 may be provided in a pair, and the pair of side portions 24 may be disposed at both left and right sides of the center portion 23. The side portion 24 may be spaced apart from the center portion 23.

A front surface of the side portion 24 may face the rear surface of the head 21. In more detail, the side portion 24 may face upper areas of both sides of the rear surface of the head 21.

The front surface of the side portion 24 and the rear surface of the head 21 may be spaced apart from each other. The ear connection portion 62 of the ear 60 may be disposed between the side portion 24 and the head 21. Thus, the ear connection portion 62 may not be seen from the outside of the head part 20.

A joint 24A may be disposed on the side portion 24. The joint 24A may protrude from the front surface of the side portion 24 toward the rear surface of the head 21.

The joint 24A may have a circular cross-section. This may be equally applied to other joints to be described later.

The joint 24A may be inserted into an insertion hole 62A defined in the ear connection portion 62 of the ear 60. Thus, the ear 60 may rotate about the joint 24A.

The connection portion 25 may connect the center portion 23 to the side portion 24. Like the side portion 24, the connection portion 25 may be provided in a pair. The pair of connection portions 25 may be connected to both ends of the center portion 23, respectively.

The connection portion 25 may include a first connection portion 25A and a second connection portion 25B.

The first connection portion 25A may be connected to both ends of the center portion 23. The first connection portion 25A may be approximately horizontal.

The second connection portion 25B may connect the first connection portion 25A to the side portion 24. The second connection portion 25B may be connected to an outer end of the first connection portion 25A. The second connection portion 25B may be approximately vertical. The second connection portion 25B may be connected to a lower side of the side portion 24 and may be spaced apart from the center portion 23.

A stepped portion 27 that is stepped forward with respect to the rear surface of the guide body 22 may be disposed on the guide body 22. The stepped portion 27 may be disposed on an upper portion of the center portion 23.

Both ends of the stepped portion 27 may guide the moving frame 53 vertically.

At least one guide rib 28 that guides the moving frame 53 may be disposed on the guide body 22. The guide rib 28 may protrude from the guide body 22, more particularly, the rear surface of the center portion 23 and may be lengthily disposed vertically.

A cross section of the guide rib 28 may have a ‘¬’ shape. In more detail, the guide rib 28 may include a protrusion 28A protruding backward from the guide body 22 and a restriction portion 28B bent from a rear end of the protrusion 28A. The restriction portion 28B may restrict the moving frame 53 in the front and rear direction.

A limiter 29 that limits descending of the moving frame 53 may be disposed on the guide body 22. The limiter 29 may protrude from the rear surface of the guide body 22. The limiter 29 may be lengthily disposed horizontally, and an inner end of the limiter 29 may be connected to an upper end of the guide rib 28.

The robot according to this embodiment may include the moving frame 53.

The moving frame 53 may have a symmetrical shape in the horizontal direction. The moving frame 53 may be integrally provided.

The moving frame 53 may be connected to the head part 20 and may move vertically to allow the ear 60 to rotate. The moving frame 53 may be guided vertically by the guide body 22 of the head part 20.

In more detail, the moving frame 53 may include a main frame 54, a movable frame 55, and a connection frame 56. The moving frame 53 may further include an upper frame 57, a lower frame 58, and a rod connector 59.

The main frame 54 may be lengthily disposed vertically. The main frame 54 may be disposed behind the guide body 22, more particularly, the center portion 23 of the guide body 22.

The main frame 54 may be provided in a pair. The pair of main frames 54 may be spaced apart from each other with the neck body 30 therebetween. The pair of main frames 54 may contact both sides of the neck body 30, respectively.

The neck body 30 may guide vertical movement of the moving frame 53. Each of the main frames 54 may be restricted between the neck body 30 and the guide ribs 28 in the horizontal direction. That is, the main frame 54 may be guided in vertical movement by the neck body 30 and the guide rib 28.

Also, at least a portion of the main frame 54 may be restricted between the center portion 23 and the restriction portion 28B in the front and rear direction.

Also, a portion of the upper side of the main frame 54 may be disposed on the stepped portion 27 of the guide body 27. That is, the portion of the upper side of the main frame 54 may be disposed to be stepped forward. A portion of the upper side of each of the main frames 54 may contact both ends of the inside of the stepped portion 27 so as to be guided vertically.

The movable frame 55 may be connected to the ear 60 to allow the ear 60 to rotate. The movable frame 55 may be disposed between the head 21 and the guide body 22. In more detail, the movable frame 55 may be disposed between the rear surface of the head 21 and the front surface of the side portion 24.

The movable frame 55 may be lengthily disposed horizontally. The movable frame 55 may be provided in a pair to allow each of the ears 60 to rotate. An outer end of the movable frame 55 may be rounded and be connected to a connection groove 62B defined in an ear connection portion 62 of the ear 60. Thus, the movable frame 55 may move vertically to allow the ear 60 to rotate.

The connection frame 56 may connect the main frame 54 to the movable frame 55. Like the movable frame 55, the connection frame 56 may be provided in a pair.

The connection frame 56 may include a first connection frame 56A and a second connection frame 56B.

The first connection frame 56A may be connected to the outside of the main frame 54. The first connection frame 56A may be disposed horizontally.

The first connection frame 56A may be disposed above the limiter 29 and be hooked with the limiter 28 so as to limited in downward movement. That is, the moving frame 53 may descend until a lower end of the first connection frame 56A contacts the limiter 29 of the guide body 22.

The second connection frame 56B may connect the first connection frame 56A and the movable frame 55. The second connection frame 56B may be connected to an outer end of the first connection frame 56A. The second connection frame 56B may be vertically disposed. The second connection frame 56B may be connected to a lower portion of the movable frame 55.

The second connection frame 56B may be disposed to be stepped forward and backward with respect to the first connection frame 56A or the movable frame 55.

At least a portion of the second connection frame 56B may be disposed between the center portion 23 and the second connecting portion 25B of the guide body 22 and may be restricted in the horizontal direction. That is, the second connection frame 56B may be guided to vertically move by the center portion 23 and the second connection portion 25B.

An upper frame 57 and the lower frame 58 may connect the pair of main frames 54 to each other. The upper frame 57 and the lower frame 58 may be lengthily disposed horizontally. The upper frame 57 and the lower frame 588 may be spaced vertically from each other with the neck body 30 therebetween.

The upper frame 57 may connect upper ends of the main frames 54 to each other. The lower frame 58 may connect lower ends of the main frames 54 to each other.

The pair of main frames 54, the upper frame 57, and the lower frame 58 may constitute an annular frame.

The neck body 30 may be coupled to the rear surface of the guide body 22. In more detail, the neck body 30 may be coupled to the rear surface of the center portion 23. An opening that avoids an inference with the neck body 30 may be defined in the moving frame 53. The opening may represent an inner region of the annular frame.

The upper frame 57 may be disposed on the stepped portion 27 of the guide body 22 and may move vertically within the stepped portion 27.

The lower frame 58 may be hooked with the neck body 30 to restrict the upward movement of the moving frame 53. That is, the neck body 30 may function as a limiter that limits the upward movement range of the moving frame 53.

The rod connector 59 may be connected to the lower frame 58. The rod connector 59 may be disposed to be elongated upward from the lower frame 59.

The rod connector 59 may be connected to the connecting rod 52 of the crank 50 which transmits the power of the sub actuator 45 (see FIG. 4). In more detail, the joint 59A protruding to the connecting rod 52 may be disposed on the upper end of the rod connector 59. The joint 59A may be rotatably inserted into a first slit 52B defined in the rod connector 52.

The robot according to an embodiment of the present invention may include a crank 50 that converts the rotational force of the sub actuator 45 (see FIG. 4) into vertical movement force of the moving frame 53.

The crank 50 may be mounted to the neck body 30.

The crank 50 may include a crank body 51 connected to the sub actuator 45 and a connecting rod 52 connecting the crank body 51 to the moving frame 53.

The crank body 51 may have an approximately circular plate shape.

The connecting rod 52 may connect the crank body 51 to the rod connector 59. The connecting rod 52 may be rotatably connected to a position that is eccentric to the central axis of the crank body 51. Also, the joint 59A provided on the rod connector 59 may be movably rotatably inserted into the first slit 52B defined in the connecting rod 52. Therefore, when the crank body 51 rotates, the connecting rod 52 may elevate the moving frame 53.

When the crank body 51 continuously rotates in one direction, the moving frame 53 may be repeatedly elevated between a first position P1 and a second position P2 that is disposed above the first position P1. Therefore, there is an advantage that the one-way rotary motor is capable of being used as the sub actuator 45.

The ear 60 may include an ear body 61 and an ear connection portion 62.

The ear body 61 may be disposed above or outside the head part 20, more particularly, the head 21. The ear body 61 is not limited in shape.

The ear connection portion 62 may be connected to the ear body 61. The ear connection portion 62 and the ear body 61 may be integrated with each other. The ear connection portion 62 may be connected to a lower portion of the ear body 61.

The ear connection portion 62 may be disposed between the head 21 and the guide body 22. In more detail, the ear connection portion 62 may be disposed between the back of the head 21 and the front of the side portion 24.

The ear connection portion 62 may be rotatably connected to the side portion 24. In more detail, an insertion hole 62A into which the guide body 22, more particularly, the joint 24A disposed on the side portion 24 is inserted may be defined in the ear connection portion 62. Thus, the ear 60 may rotate about the joint 24A of the side portion 24.

The ear connection portion 62 may be connected to the moving frame 53. In more detail, a connection groove 62B to which the movable frame 55 is connected may be defined in the ear connection portion 62. In more detail, the joint protruding backward may be disposed on the outer end of the movable frame 55, and the slit into which the joint is rotatably inserted may be defined in the connection groove 62B of the ear connection portion 62.

The connecting groove 62B may be eccentric with respect to the insertion hole 62A. Thus, when the moving frame 53 ascends, the movable frame 55 may push the ear connection portion 62 upward, and the ear 60 may rotate in one direction. On the contrary, when the moving frame 53 descends, the movable frame 55 may push the ear connection portion 62 downward, and the ear 60 may rotate in the other direction.

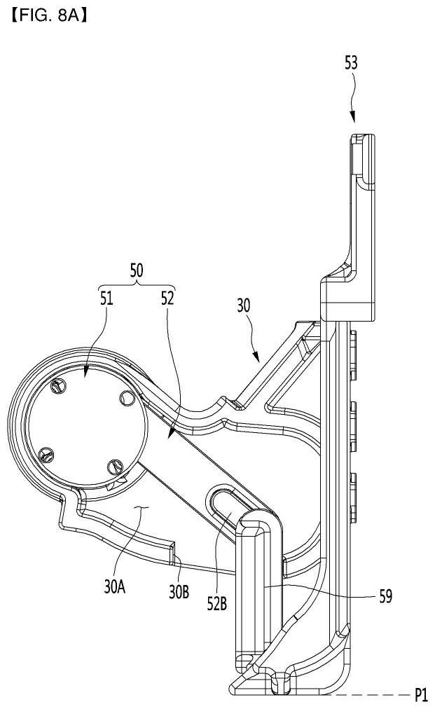

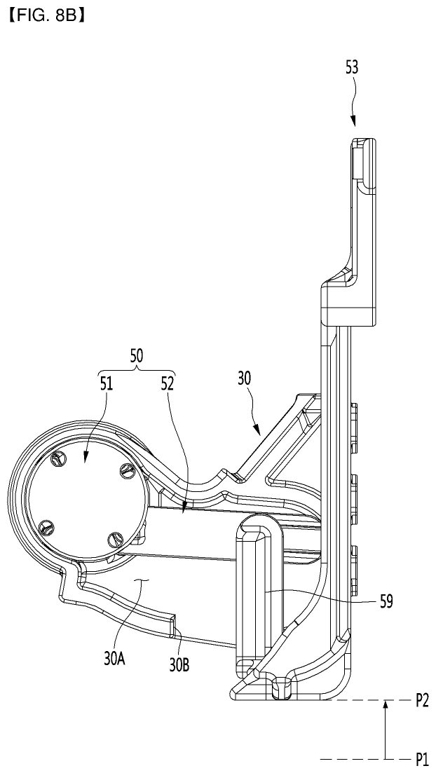

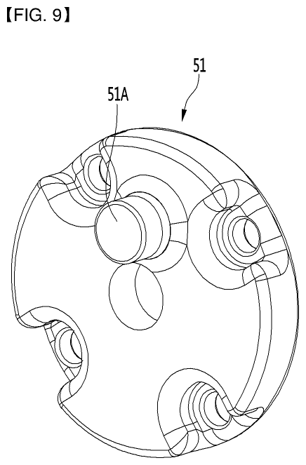

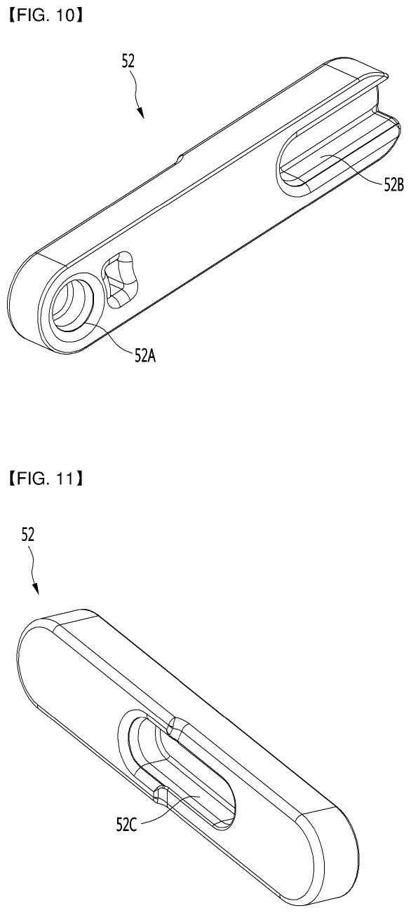

FIGS. 8A and 8B are views illustrating vertical movement of the moving frame according to an embodiment of the present invention, FIG. 9 is a perspective view of a crank body according to an embodiment of the present invention, FIG. 10 is a view of the connecting rod when viewed from one side according to an embodiment of the present invention, and FIG. 11 is a view of the connecting rod when viewed from the other side according to an embodiment of the present invention.

An accommodation groove 30A in which the crank 50 is accommodated may be defined in the neck body 30. The accommodation groove 30A may be defined in a surface of both surfaces of the neck body 30, which faces the sub actuator 45 (see FIG. 3).

The crank body 51 may contact an inner circumference of the accommodation groove 30A so as to be rotatably supported. The accommodation groove 30A may have a sufficient size so as not to interfere with the moving connecting body 52.

A through-groove 30B which communicates with the accommodation groove 30A and through which the rod connector 59 passes may be defined in the neck body 30. The through-groove 30B may be defined by cutting or passing through from the bottom surface of the neck body 30 to the accommodation groove 30A. The rod connector 59 of the moving frame 53 may be connected to the rod connector 59 by passing through the through-groove 30B from a lower side.

A joint 51A protruding toward the connecting rod 52 may be disposed on the crank body 51. An insertion groove 52A into which the joint 51A disposed on the crank body 50 is rotatably inserted may be defined in the connecting rod 52. The insertion groove 52A may be defined in a surface of both surfaces of the connecting rod 52, which faces the crank body 51.

A first slit 52B into which the joint 59A (see FIG. 5) disposed on the rod connector 59 is movably inserted and a second slit 52C into which the joint disposed on the neck body 30 is movably inserted may be defined in the connecting rod 52.

The joint disposed on the neck body 30 may protrude toward the connecting rod 52 from the inner surface of the accommodation groove 30A and be inserted into the second slit 52C. As a result, the connecting rod 52 may be rotatably and movably supported inside the accommodation groove 30A.

The first slit may be defined in a surface of both surfaces of the connecting rod 52, which faces the rod connector 59. The second slit may be defined in a surface opposite to the surface in which the first slit is defined. That is, the insertion groove 52A and the first slit 52B may be defined in one surface of the connecting rod 52, and the second slit 52C may be defined in the other surface of the connecting rod 52.

The insertion groove 52A may be defined in one end of the connecting rod 52, and the first slit 52B may be defined in the other end of the connecting rod 52. The first slit 52B may be defined to be lengthily defined in a longitudinal direction of the connecting rod 52, and an outer end of the first slit 52B may be opened.

The second slit 52C may be defined to be lengthily defined in the longitudinal direction of the connecting rod 52. The second slit 52C may be defined in a central portion of the connecting rod 52.

The above-disclosed subject matter is to be considered illustrative, and not restrictive, and the appended claims are intended to cover all such modifications, enhancements, and other embodiments, which fall within the true spirit and scope of the present disclosure.

Thus, the embodiment of the present disclosure is to be considered illustrative, and not restrictive, and the technical spirit of the present disclosure is not limited to the foregoing embodiment.

Therefore, the scope of the present disclosure is defined not by the detailed description of the invention but by the appended claims, and all differences within the scope will be construed as being included in the present disclosure.

1. A robot comprising:
a head part;
an ear rotatably connected to the head part;
a moving frame connected to the head part, the moving frame moving vertically to allow the ear to rotate;
a neck body coupled to the heat part;
a main actuator configured to allow the neck body to rotate; and
a sub actuator configured to allow the moving frame to move vertically,
wherein the main actuator and the sub actuator are disposed to be symmetrical to each other with respect to the neck body.

2. The robot according to claim 1, wherein a rotation axis of the main actuator and a rotation axis of the sub actuator are disposed in a straight line.

3. The robot according to claim 1, wherein an opening configured to avoid an interference with the neck body is defined in the moving frame.

4. The robot according to claim 1, wherein the main actuator and the sub actuator contact both sides of the neck body, respectively.

5. The robot according to claim 1, further comprising:
a crank body connected to the sub actuator; and
a connecting rod configured to connect the crank body to the moving frame,
wherein the moving frame comprises a rod connector connected to the connecting rod.

6. The robot according to claim 5, wherein the connecting rod comprises:
an insertion groove into which a joint disposed on the crank body is rotatably inserted;
a first slit into which a joint disposed on the rod connector is movably inserted; and
a second slit into which a joint disposed on the neck body is movably inserted.

7. The robot according to claim 5, wherein the neck body comprises:
an accommodation groove in which the crank body and the connecting rod are disposed; and
a through-groove which communicates with the accommodation groove and through which the rod connector passes.

8. The robot according to claim 1, wherein the head part comprises:
a head; and
a guide body coupled to a rear surface of the head, the guide body being configured to guide the vertical movement of the moving frame.

9. The robot according to claim 8, wherein at least one of the moving frame or the guide body has a bilaterally symmetrical shape.

10. The robot according to claim 8, wherein at least one guide rib protruding from a rear surface of the guide body to guide the moving frame is disposed on the guide body.

11. The robot according to claim 10, wherein the guide rib comprises:
a protrusion protruding backward from the guide body; and
a restriction portion bent from a rear end of the protrusion to restrict forward and backward movement of the moving frame.

12. The robot according to claim 8, wherein the ear comprises:
an ear body disposed above or outside the head; and
an ear connection portion connected to the ear body, disposed between the head and the guide body, and connected to the moving frame.

13. The robot according to claim 12, wherein the ear connection portion comprises:
an insertion hole into which a joint disposed on the guide body is rotatably inserted; and
a slit into which a joint disposed on the moving frame is rotatably inserted.

14. The robot according to claim 8, wherein the moving frame comprises:
a pair of main frames lengthily disposed in a vertical direction, the pair of main frames being disposed at a rear side of the guide body;
a movable frame connected to the ear to allow the ear to rotate, the movable frame being disposed between the head and the guide body; and
a connection frame configured to connect the main frames to the movable frame.

15. The robot according to claim 1, wherein the moving frame comprises:
a pair of main frames spaced apart from each other with the neck body therebetween, the pair of main frames being lengthily disposed in a vertical direction;
a movable frame connected to the ear to allow the ear to rotate; and
a connection frame configured to connect to the main frames to the movable frame.

16. The robot according to claim 15, wherein the pair of main frames contact both ends of the neck body, respectively.

17. The robot according to claim 15, wherein the moving frame further comprises:
a lower frame disposed below the neck body to connect the pair of main frames to each other; and
a rod connector protruding upward from the lower frame, the rod connector being connected to a connecting rod configured to transmit power of the sub actuator.

18. The robot according to claim 1, further comprising:
a movable body to which the main actuator and the sub actuator are fixed and to which the neck body is rotatably connected; and
a moving actuator configured to allow the movable body to rotate.

19. The robot according to claim 18, wherein the movable body has a bilaterally symmetrical shape.

20. A robot comprising:
a body part;
a head part spaced upward from the body part;
a neck body coupled to the head part;
a movable assembly configured to connect the body part to the neck body, the movable assembly comprising a plurality of movable bodies that are connected to be rotatable with respect to each other;
a moving frame connected to the head part so as to be movable vertically;
a main actuator configured to allow the neck body to rotate; and
a sub actuator configured to allow the moving frame to move vertically,
wherein the main actuator and the sub actuator are fixed to the movable assembly and are symmetrical to each other with respect to the neck body.
